(19) United States
(12) Patent Application Publication
(10) Pub. No.: US 2013/0038980 A1
(43) Pub. Date: Feb. 14, 2013

(54) INNER ELECTRODE, AND MULTILAYERED CERAMIC CAPACITOR COMPRISING THE INNER ELECTRODE

(71) Applicants: Woon Chun KIM, Gyeonggi-do (KR); Hyun Ho LIM, Gyeonggi-do (KR); Sung Kwon WI, Seoul (KR); Kyu Sang LEE, Gyeonggi-do (KR)

(72) Inventors: Woon Chun KIM, Gyeonggi-do (KR); Hyun Ho LIM, Gyeonggi-do (KR); Sung Kwon WI, Seoul (KR); Kyu Sang LEE, Gyeonggi-do (KR)

(21) Appl. No.: 13/572,448

(22) Filed: Aug. 10, 2012

(30) Foreign Application Priority Data
Aug. 12, 2011 (KR) 10-2011-0080763

(51) Int. Cl. H01G 4/008; H01G 4/30

(52) U.S. Cl. 361/301.4

(57) ABSTRACT

Disclosed herein are inner electrodes of a multilayered ceramic capacitor including metal powders including graphene layers formed on a surface thereof and a multilayered ceramic capacitor including the inner electrodes. An exemplary embodiment of the present invention can include metal powders including graphene layers formed on a surface thereof as inner electrode materials of a multilayered ceramic capacitor to more effectively prevent necking of the metal powders than the related art including only dielectric ceramic powders, thereby increasing necking temperature and necking and control inner electrode shrinkage, thereby reducing a thickness of the inner electrode and defects such as short/cracks, and the like, of the inner electrode. Therefore, it is possible to provide the multilayered ceramic capacitor with excellent reliability by minimizing a difference in shrinkage between the dielectric layer and the inner electrodes.

### CROSS REFERENCE(S) TO RELATED APPLICATIONS

This application claims the benefit under 35 U.S.C. Section 119 of Korean Patent Application Serial No. 10-2011-0080763, entitled “Inner Electrode, And Multilayered Ceramic Capacitor Comprising the Inner Electrode” filed on Aug. 12, 2011, which is hereby incorporated by reference in its entirety into this application.

### BACKGROUND OF THE INVENTION

1. Technical Field

The present invention relates to inner electrodes and a multilayered ceramic capacitor comprising the inner electrodes.

2. Description of the Related Art

A multilayered ceramic capacitor (MLCC) has inner electrodes included in a dielectric ceramic and is manufactured by firing the dielectric ceramic at a temperature of about 900° C.

In this case, as a material of the inner electrode, a nickel (Ni) powder is mainly used and as a dielectric ceramic powder, BaTiO₃ is mainly used. When simultaneously firing the dielectric ceramic comprising the inner electrodes, a necking phenomenon of aggregating nickel metal occurs due to a difference in shrinkage between the nickel metal that forms the inner electrodes and the dielectric ceramic BaTiO₃ powder. Therefore, defects such as cracks, delamination, and the like, occur in the inner electrodes due to a mismatch between the inner electrodes and the dielectric layer.

Next, FIG. 1 shows a portion of a cross section of the MLCC structure having the inner electrodes included in the dielectric ceramic.

Referring to FIG. 1, the MLCC has a structure in which a dielectric layer 10 made of a dielectric ceramic powder 11 and inner electrodes 20 are stacked in the dielectric layer 10. In this structure, a short between the inner electrodes occurs (A) due to the difference in shrinkage at the time simultaneously firing the dielectric ceramic comprising the inner electrodes 20, which leads to degradation in smoothness and connectivity of the inner electrodes.

In addition, the inner electrodes 20 are permeated (B) into the dielectric layer 10 to degrade reliability of the dielectric layer 10 or reduce breakdown voltage (BDV).

Therefore, as one method for solving the problems, in order to reduce the shrinkage of the inner electrode, a technology of mixing the same ceramic powder as the material forming the dielectric layer with the nickel powder forming the inner electrodes using inhibitors.

Next, FIG. 2 shows effects obtained by mixing the inner electrodes of nickel with the dielectric ceramic powder using the inhibitors. Referring to FIG. 2, nickel powders 21 forming the inner electrodes form the necking at low temperature and a structure in which the nickel powders are aggregated is shown. When the necking frequently occurs between the nickel powder particles, the sintering may be rapidly performed. As a result, there is a need to prevent the necking from occurring.

In order to reducing the shrinkage of the inner electrodes, when the dielectric ceramic powder inhibitors 11 are added, the dielectric ceramic powder inhibitors 11 are disposed at contacts at which the nickel powder particles 21 contact each other, thereby preventing the necking of the nickel powder and delaying the sintering. In addition, the method of separating the added dielectric ceramic powder inhibitors 11 from the nickel inner electrodes when the nickel powders form the inner electrodes and joining them to the dielectric layer is used.

However, the method has a limited effect as the firing temperature is increased and cannot control the difference in shrinkage to the desired level, such that it is difficult to effectively control the difference in shrinkage between the nickel powder forming the inner electrodes and the dielectric ceramic powder forming the dielectric layer.

### SUMMARY OF THE INVENTION

An object of the present invention is to provide inner electrodes having a structure with shrinkage property similar to a dielectric layer so as to solve several problems of the related art due to a difference in shrinkage of materials used for the inner electrodes and the dielectric layer of a multilayered ceramic capacitor.

In addition, another object of the present invention is to provide a multilayered ceramic capacitor comprising the inner electrodes.

According to an exemplary embodiment of the present invention, there is provided an inner electrode of a multilayered ceramic capacitor including metal powders including graphene layers formed on a surface thereof.

The inner electrode may further include one or more selected from the group consisting of the metal powders that do not include the graphene layers or dielectric ceramic powders.

The metal powders may be one or more selected from the group consisting of Ni, Cu, Co, Fe, Pt, Au, Al, Cr, Mg, Mn, Mo, Rh, Si, Ta, Ti, W, U, V, and Zr.

The metal powders including the graphene layers formed on the surface thereof may be included at about 50 wt % in compositions forming all the inner electrodes.

The graphene layer may be set to be a thickness of 1 μm.

The graphene layer may be formed in a multi layer of one layer or more.

The metal powders including the graphene layers formed on the surface thereof may have one or more selected from the group consisting of a spherical shape, a squared shape, a polyhedral shape, and a cylindrical shape and is not limited thereto.

According to another exemplary embodiment of the present invention, there is provided a multilayered ceramic capacitor comprising the inner electrode as described above.

### BRIEF DESCRIPTION OF THE DRAWINGS

FIG. 1 is a diagram showing a portion of a cross section of the MLCC structure having inner electrodes included in a dielectric ceramic.

FIG. 2 is a diagram showing effects obtained by mixing the inner electrodes of nickel with a dielectric ceramic powder using inhibitors.

FIG. 3 is an example of a structure of metal powders including the graphene layers formed on the surface thereof according to the exemplary embodiment of the present invention.

FIG. 4 shows a necking phenomenon of the metal powders including the graphene formed on the surface thereof prepared according to the exemplary embodiment of the present invention.

FIGS. 5 and 6 each are diagrams comparing benzene ring with the atom size of the metal powders according to the exemplary embodiment of the present invention.

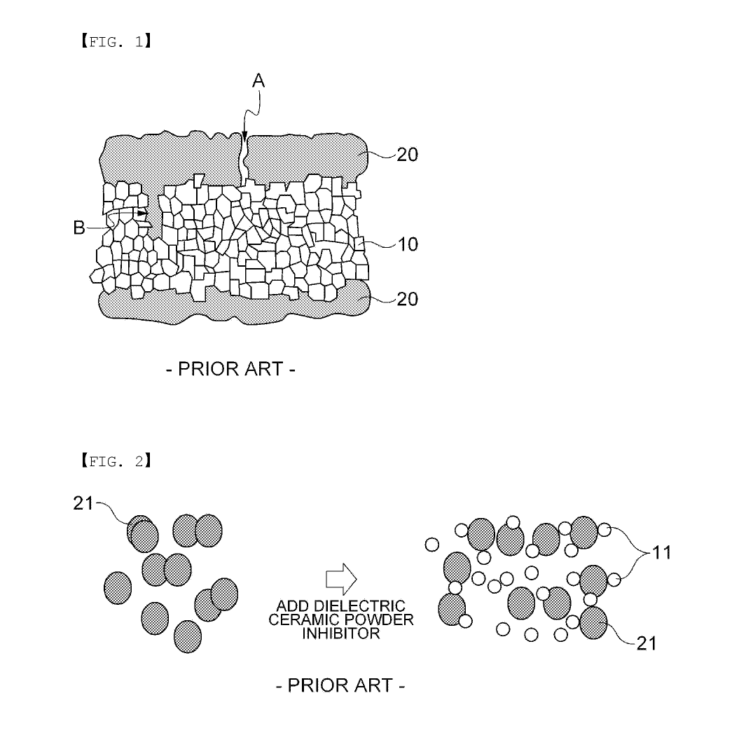

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to inner electrodes and multilayered ceramic capacitors comprising the inner electrodes.

The inner electrodes according to the exemplary embodiment of the present invention include metal powders including graphene layers formed on a surface thereof.

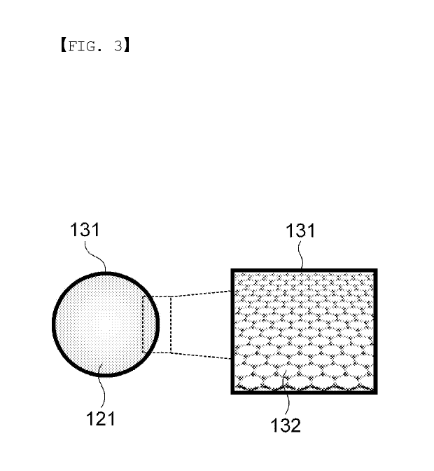

Next, FIG. 3 shows an example of a structure of the metal powders including the graphene layers formed on the surface thereof according to the exemplary embodiment of the present invention. Referring to FIG. 3, the metal powders have a structure in which graphene layers 131 are uniformly formed on the surface thereof. Reviewing a photograph in which the surface of the metal powders 121 is enlarged, it can be appreciated that the graphene layers 131 have a coupling structure similar to graphene sheets in which carbons are connected to each other by a hexagonal plate shape structure 132.

In addition, the graphene maintains an appropriate coupling angle and may have a curved spherical shape, a cylindrical shape, a polyhedral shape, and the like. Therefore, according to the exemplary embodiment of the present invention, the metal powders including the graphene layers formed on the surface thereof may have one or more selected from the group consisting of a spherical shape, a squared shaped, a polyhedral shape, and a cylindrical shape, but is not limited thereto.

When the metal powders including the graphene layers formed on the surface thereof according to the embodiment of the present invention have a spherical shape, a diameter thereof may be preferably set to be several hundreds of nm or less.

In addition, when the metal powders including the graphene layers formed on the surface thereof according to the embodiment of the present invention have a polyhedral shape, a thickness thereof may be preferably set to be several hundreds of nm or less.

According to the exemplary embodiment of the present invention, a method for preparing metal powders including graphene layers formed on the surface thereof includes: coating the surface of each metal powder with a carbon supply source by injecting the carbon supply source to the metal powders, heat-treating the coated metal powders, and generating graphenes on the surface of the metal powders.

The metal powders may be one or more selected from the group consisting of Ni, Cu, Co, Fe, Pt, Au, Al, Cr, Mg, Mn, Mo, Rh, Si, Ta, Ti, W, U, V, and Zr but is not limited thereto.

In addition, if the carbon supply source may form the graphenes by the heat treatment that is the following process, the materials of the carbon supply source are not particularly limited. For example, an example of the materials may include carbon containing polymers such as amphiphilic polymer, liquid crystal polymer, conductive polymer; liquid carbon-based materials such as alcoholic organic solvent; vapor carbon-based materials such as methane, ethane, acetylene, and the like, but is not limited thereto.

The heat-treatment conditions may be preferably performed under the inert atmosphere of 400 to 1500° C. or for 0.1 to 10 under the reduction atmosphere.

The heat treatment may be performed by one or more method selected from the group consisting of induction heating, radiation, laser, IR, microwave, plasma, UV, and surface plasmon heating, but is not limited thereto.

The rest components other than carbon component of the carbon supply source is volatilized by the above-mentioned heat treatment and only the carbon components are coupled with each other to form three-dimensional graphene layer.

The graphene layer formed on the surface of the metal powders may be appropriate to have a thickness of 1 μm or less, preferably, several nm.

In addition, the graphene layer may be formed in one layer or more, preferably, 100 layers or more, more preferably, multi layers of about 10 layers. This may be formed by a multi-layer graphene layer due to the difference between solubility of materials provided to the carbon supply source due to the heat treatment.

Other inner electrodes according to the exemplary embodiment of the present invention may include about 50 wt % of metal powders including the graphene layers in compositions forming all the inner electrodes. When the metal powders including the graphene layers exceed 50 wt %, the metal powders may be not sintered.

In addition, other inner electrodes according to the exemplary embodiment of the present invention may use the metal powders that do not include the graphene layers, along with the metal powders including the graphene layers.

Optionally, other inner electrodes may further include dielectric ceramic powders forming the dielectric layer.

The inner electrodes according to the exemplary embodiment of the present invention is manufactured in a paste form by mixing a binder, a solvent, other additives, and the like, in the compositions and thus, are formed in the dielectric layer. The binder, the solvent, other additives are not particularly limited and ones that may be used for the inner electrodes of the general multilayered ceramic capacitor may be used without being limited.

Next, FIG. 4 shows inner electrode paste compositions according to the exemplary embodiment of the present invention. It can be appreciated from FIG. 4 that metal powders 140 including the graphene layers formed on the surface thereof and metal powders 150 for the inner electrode materials that do not include the graphene layers may be uniformly dispersed within the paste including the solvent and a binder 160.

The exemplary embodiment of the present invention provides the multilayered ceramic capacitor including the aforementioned inner electrodes.

In the inner electrodes according to the exemplary embodiment of the present invention, the metal powders used as the existing MLCC inner electrodes are mixed with the metal powders including the graphenes surrounding the surface thereof, instead of a dielectric ceramic inhibitor or together with an inhibitor. Therefore, the necking of the metal powders can be more effectively prevented than the case in which the metal powders include only the existing dielectric ceramic inhibitor to increase the necking temperature and the necking and inner electrode shrinkage is controlled to reduce the thickness of the inner electrode and the crack and short of the inner electrode, thereby improving the reliability.

Unlike the dielectric ceramic inhibitor according to the related art, the metal powders including the graphenes surrounding the surface thereof according to the exemplary embodiment of the present invention remain in the inner electrodes without separating from the inner electrodes, thereby effectively controlling the necking of the metal powders used as the inner electrodes.

In addition, the metal powders used as the existing inner electrode materials serve as a graphite catalyst forming the graphenes on the surface thereof, such that the graphenes can more stably remain at high temperature. Further, the graphene characteristics can be more improved due to the removal of impurities, and the like, and thus, the inner electrode conductivity of the conductor is not affected.

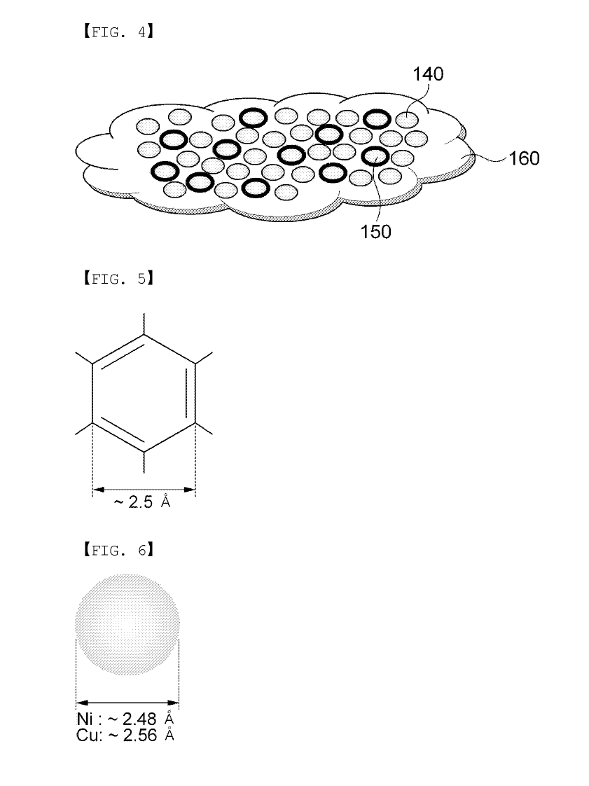

In addition, the graphene is formed of carbons having the hexagonal plate shape structure and the structure is similar to the benzene ring. Next, as can be appreciated from FIGS. 5 and 6, the atom sizes of the benzene ring (FIG. 5) and the metal powders (FIG. 6) are similar to each other and thus, it is difficult to move metals through the carbon hexagonal ring of the graphene.

According to the exemplary embodiment of the present invention, the metal powders having the graphene layers formed on the surface thereof are included as the inner electrode materials of the multilayered ceramic capacitor to more effectively prevent the necking of the metal powders than the related art including only the dielectric ceramic powder, thereby increasing the necking temperature and can control the necking and the shrinkage of the inner electrodes, thereby reducing the defects such as short/cracks, and the like, while reducing the thickness of the inner electrode.

Therefore, it is possible to provide the multilayered ceramic capacitor with excellent reliability by minimizing the difference in shrinkage between the dielectric layer and the inner electrodes.

Although the present invention has been shown and described with the exemplary embodiment as described above, the present invention is not limited to the exemplary embodiment as described above, but may be variously changed and modified by those skilled in the art to which the present invention pertains without departing from the scope of the present invention.

What is claimed is:

1. An inner electrode of a multilayered ceramic capacitor including metal powders including graphene layers formed on a surface thereof.

2. The inner electrode of a multilayered ceramic capacitor according to claim 1, wherein the inner electrode further includes one or more selected from the group consisting of the metal powders that do not include the graphene layers or dielectric ceramic powders.

3. The inner electrode of a multilayered ceramic capacitor according to claim 1, wherein the metal powders are one or more selected from the group consisting of Ni, Cu, Co, Fe, Pt, Au, Al, Cr, Mg, Mn, Mo, Rh, Si, Ta, Ti, W, U, V, and Zr.

4. The inner electrode of a multilayered ceramic capacitor according to claim 2, wherein the metal powders are one or more selected from the group consisting of Ni, Cu, Co, Fe, Pt, Au, Al, Cr, Mg, Mn, Mo, Rh, Si, Ta, Ti, W, U, V, and Zr.

5. The inner electrode of a multilayered ceramic capacitor according to claim 1, wherein the metal powders including the graphene layers formed on the surface thereof are included at about 50 wt % in compositions forming all the inner electrodes.

6. The inner electrode of a multilayered ceramic capacitor according to claim 1, wherein the graphene layer is set to be a thickness of 1 μm or less.

7. The inner electrode of a multilayered ceramic capacitor according to claim 1, wherein the graphene layer is formed in a multi layer of one layer or more.

8. The inner electrode of a multilayered ceramic capacitor according to claim 1, wherein the metal powders including the graphene layers formed on the surface thereof has one or more selected from the group consisting of a spherical shape, a squared shape, a polyhedral shape, and a cylindrical shape.

9. A multilayered ceramic capacitor comprising the inner electrode according to claim 1.
